(19) United States
(12) Patent Application Publication
(10) Pub. No.: US 2008/0098319 A1
(43) Pub. Date: Apr. 24, 2008

(54) Method and apparatus for interacvtive multimedia author tool and dynamic toolbar

(76) Inventor: Gary Lucas, West Chester, OH (US)

Correspondence Address: MCDERMOTT WILL & EMERY LLP, 600 13TH STREET, N.W., WASHINGTON, DC, 20005-3096, US

(21) Appl. No.: 11/976,109

(22) Filed: Oct. 22, 2007

Related U.S. Application Data
(60) Provisional application No. 60/853,029, filed on Oct. 20, 2006.

(51) Int. Cl. G06F 3/048

(52) U.S. Cl. 715/765

(57) ABSTRACT

A method of relying upon intelligent feedback to create a dynamic toolbar that provides navigation and creation options that change dependant upon the location of the dynamic toolbar and the type of multimedia page being viewed.

### RELATED APPLICATION

This application claims priority to U.S. Patent Application Ser. No. 60/853,029, filed on Oct. 20, 2006, which Application is incorporated herein in its entirety by this reference.

### FIELD OF THE INVENTION

The present invention relates to multimedia tools, and in particular, it relates to an interactive multimedia author tool for an interactive multimedia interface employing multiple types of media.

### BACKGROUND

Currently, the multimedia industry utilizes software for creating and editing projects with the assistance of conventional pulldown menus. Many instances of pulldown menus to create and manipulate projects exist in the literature but, in most cases, such pulldown menus are static. That is, conventional pulldown menus require the user to navigate to predetermined locations in an application in order to perform most tasks via the use of the pulldown menu. In addition, many programs have program tool bars and pull down menus for similar functions but with very different organization. Consequently, in order to efficiently use a particular program, the user is required to become familiar with the particular organization of the program. The user must learn how to use each individual program by memorizing the general organization of the pulldown menus for each program. For example, a word processor program may be used for text editing applications, a media program may be used for editing video, a media program may be used for editing voice, and so on. All of these programs have unique program menus and organization. As a result, it is difficult to use multiple programs due to the learning curve required to become efficient at using those programs.

Accordingly, there is a need for a more effective method of editing content in any given program, and there is a need for a more effective method of consolidating options available to the user in a basic user interface.

### SUMMARY

In an effort to solve the foregoing problems, a dynamic toolbar is provided in lieu of, or in addition to, conventional pulldown menus. Such a dynamic toolbar provides navigation and creation options not currently available in conventional pulldown menus. The dynamic toolbar presents the user with a number of options that are not currently available through the use of conventional pulldown menus. The dynamic toolbar options change dependant upon the location of the dynamic toolbar and the type of multimedia page being viewed.

Additional objects, advantages and novel features of various examples will be set forth in part in the description which follows, and in part will become apparent to those skilled in the art upon examination of the following and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF DRAWINGS

The drawing figures depict embodiments of the concepts by way of example, not by way of limitations. In the figures, like reference numerals refer to the same or similar elements.

FIG. 1 illustrates an exemplary application interface supporting multiple media applications and an associated dynamic toolbar for creating and editing each media application.

FIGS. 2A-2D respectively illustrates implementations of the dynamic toolbar.

FIG. 3 illustrates a flow chart useful for explaining the operation of the dynamic toolbar.

FIG. 4 illustrates a flow chart useful for explaining additional functionality of the dynamic toolbar.

FIGS. 5A-5D illustrates functional block diagrams associated with the functionality represented in FIG. 4.

FIG. 6 illustrates an exemplary block diagram of a computer or computer system for use with the disclosed concepts.

### DETAILED DESCRIPTION

The dynamic toolbar for interactive multimedia author tool replaces or is used in addition to the conventional pulldown menu. The dynamic toolbar is particularly useful within a multimedia program that supports a plurality of media types, such as text, video, sound, within a single application. The dynamic toolbar allows a user to create and edit each of the plurality of media types via the use of intelligent feedback. This provides navigation and creation options that are currently not available to conventional pulldown menus. For instance, the dynamic toolbar options available to the user change relative to its location within the viewable area of an application. Options also may change based on the type of multimedia page being viewed. In order to change the options available to the user, the user does not need to click the mouse. The user only needs to change the position of the dynamic toolbar by moving the mouse. Consequently, a single user interface can be used to author the various media applications to provide a multimedia experience which is significantly enhanced and the user learning curve is greatly reduced.

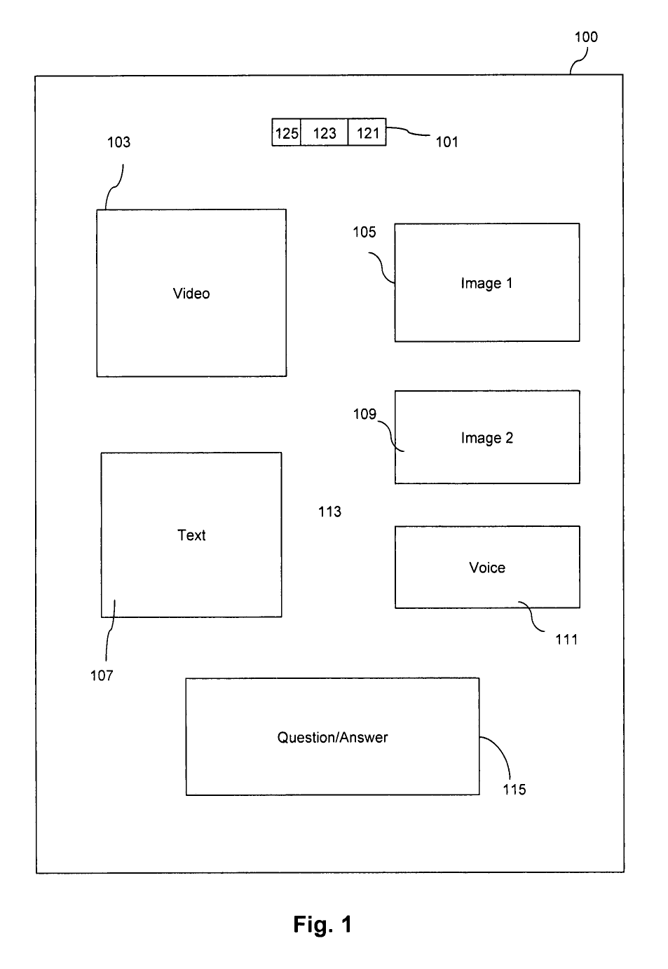

FIG. 1 illustrates an exemplary application interface supporting multiple media applications and the dynamic toolbar 101. The dynamic toolbar 101 is navigable over the entire area of the interface, referred to herein below as the multimedia page 100. Multimedia page 100 provides multiple media types in a single interface such as audio, video, text and sound. The multimedia page comprises a plurality of content areas 103, 105, 107, 109, 111 and 115 providing media types such as video, a first image, text, a second image, voice and question and answer applications, respectively. The background area 113 corresponds to the portion of the multimedia page 100 not occupied by the aforementioned content areas.

In addition, the application is hierarchical such that the multimedia page 100 provides basic information to all aforementioned media types within the program. In this implementation, the multimedia page 100 may be a main page. There are a media page and question/answer page subordinate to the main page, which are initiated by a link from the main page such as by clicking the mouse on an associated content area. The media page (not shown) provides advanced media, audio and video options not available to the main page. The question/answer page (not shown) provides advanced media, audio, video and question/answer options not available to the main page.

Each content area 103, 105, 107, 109, 111 and 115 may be resizable and may be positioned anywhere within multimedia page 100. The plurality of content areas 103, 105, 107, 109, 111 and 115 may contain various types of multimedia such as video, audio, images, text, recorded sound, sound, comments and question and answers, as mentioned above, and these contents may be edited by a user. The background area 113 may also be changed, i.e., the color of background area 113 and various menu options are available for background area 113.

Content area 107 may contain text from a document, table of contents information, chapter information, etc. Content areas 103, 105, 109, and 111 may contain video, audio, images, recorded sound, or sound. Content area 115 may contain question and answers. The combination of the content areas in a single interface provides a multimedia program supporting numerous media types.

In one embodiment, multimedia page 100 may be a multimedia book. A multimedia book is created by the user by importing text from a document into multimedia page 100. The dynamic toolbar 101 allows the user to assemble a multimedia project by linking the multimedia book with various assembled media panels. For example, the user may associate words, sentences, paragraphs, ideas of the multimedia book with various forms of multimedia, such as text, video, sound, within a single application. As a result, the user may create a multimedia book that is fully navigable by the user and has a number of multimedia options.

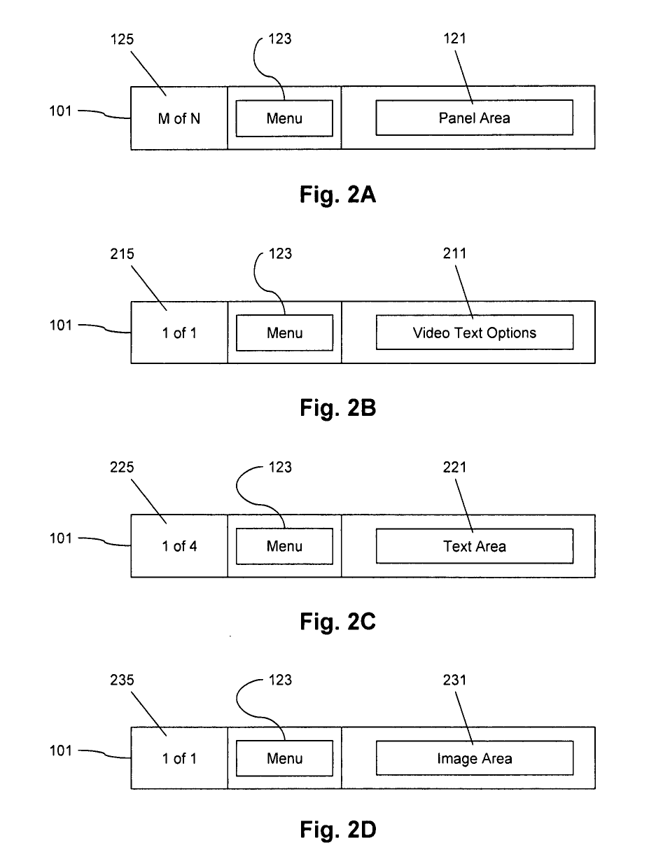

FIG. 2A illustrates an exemplary block diagram of one aspect of the dynamic toolbar 101 also illustrated by FIG. 1. Dynamic toolbar 101 has an information window 121, a pulldown menu 123 and an index button 125. Dynamic toolbar 101 is navigable over the entire area of multimedia page 100, including each content area 103, 105, 107, 109, 111 and 115 and background area 113 contained within multimedia page 100. As the dynamic toolbar 101 is navigated over any of the content areas and background area, information displayed in the information window 121 of the toolbar, changes depending on the aforementioned area over which it is positioned. In addition, the options for the pulldown menu 123 also change.

Dynamic toolbar 101 also contains an index button 125 that notifies the user of the number of mouse clicks available in order to change the background color options, text color options, font options and other menu options. As a result, dynamic toolbar 101 allows the user a number of multimedia options that changes with the location of the dynamic toolbar 101 and the type of multimedia page 100 being navigated. Thus, the options available to the dynamic toolbar 101 change dependant upon if the dynamic toolbar 101 is positioned over each content area 103, 105, 107, 109, 111 and 115 and background area 113.

Each content area 103, 105, 107, 109, 111 and 115 and background area 113 have predefined spatial coordinates that indicate their position on the multimedia page 100. The predefined spatial coordinates can be changed if a user resizes any of the content areas 103, 105, 107, 109, 111 and 115 or background area 113. The background area 113 has spatial coordinates corresponding to the portion of the multimedia page 100 not occupied by any of the content areas 103, 105, 107, 109, 111 and 115.

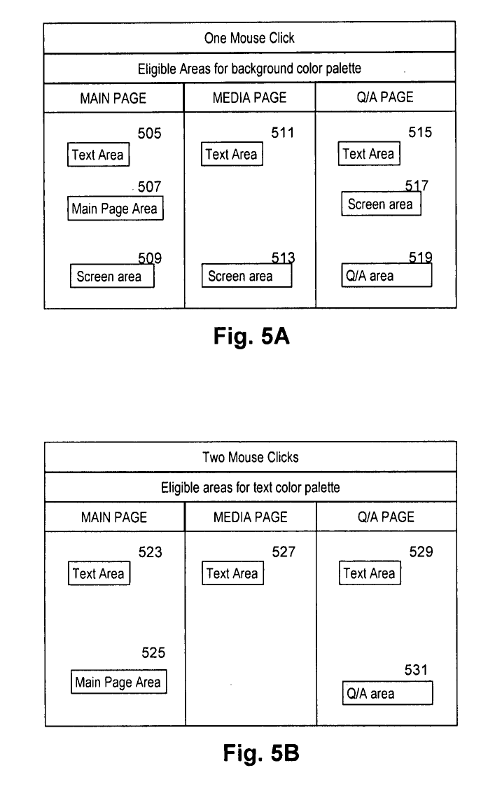

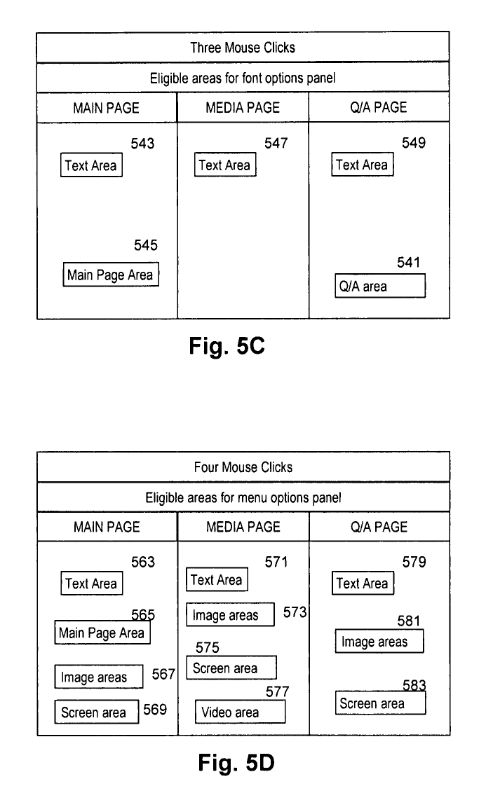

FIG. 2B illustrates an exemplary block diagram of one aspect of the dynamic toolbar 101 when the content area 103 field contains “Video” information. In this embodiment, the dynamic toolbar 101 is positioned over the content area 103 field and as a result, the information window 211 displays “Video Area.” Index button 215 displays “1 of 1” in order to notify the user that only 1 of the background color, text color, font and other menu options available for use. The tables shown in FIGS. 5A-5D illustrate the eligible areas for the background color, text color, font and other menu options.

FIG. 2C illustrates an exemplary block diagram of one aspect of the dynamic toolbar 101 when the content area 107 field contains “Text” information. In this embodiment, the dynamic toolbar 101 is positioned over the content area 107 field and as a result, the information window 211 displays “Text Area.” Index button 225 displays “1 of 4” in order to notify the user that this is 1 of the 4 available options (background color, text color, font and menu) available for use. The tables shown in FIGS. 5A-5D illustrate the eligible areas for the background color, text color, font and other menu options.

FIG. 2D illustrates an exemplary block diagram of one aspect of the dynamic toolbar 101 when the content area 105 field contains “Image” information. In this embodiment, the dynamic toolbar 101 is positioned over the content area 105 field and as a result, the information window 221 displays “Image Area.” Index button 215 displays “1 of 1” in order to notify the user that only 1 of the background color, text color, font and other menu options is available for use. The tables shown in FIGS. 5A-5D illustrate the eligible areas for the background color, text color, font and other menu options.

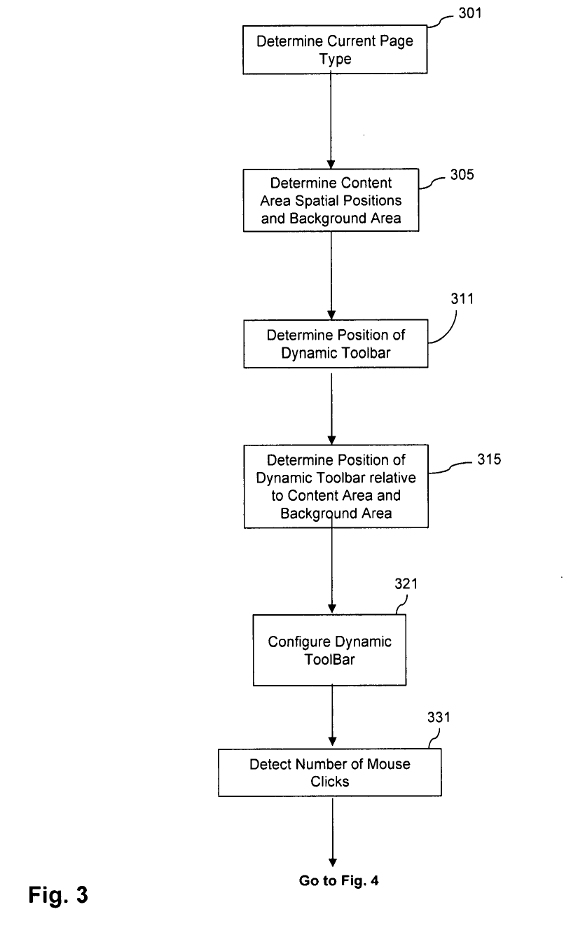

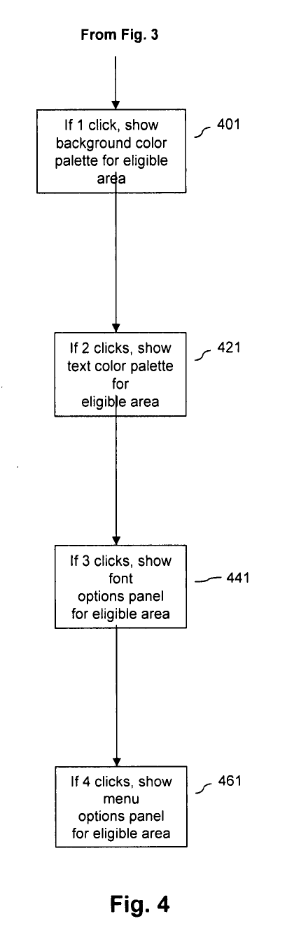

FIG. 3 illustrates an exemplary flow chart useful for explaining the operation of an embodiment of the dynamic toolbar. Generally, the dynamic toolbar feedback process detects the type of page being viewed and determines the spatial positioning of the dynamic toolbar 101, input by the user and the options eligible for the dynamic toolbar 101. Referring to FIG. 3, the method begins or starts at step 301, wherein the current multimedia page 100 being navigated is determined. In this embodiment, the multimedia page 100 can be a main page, a media page or a question/answer page. For example, multimedia page 100 may be a completely new page or some combination of the main page, media page and/or question/answer page.

Step 305 determines the spatial positioning of content area 103, 105, 107, 109, 111 and 115 and background area 113 on multimedia page 100. Each content area 103, 105, 107, 109, 111 and 115 and background area 113 may be resizable and may be positioned anywhere within multimedia page 100 and therefore the most current positions of each content area 103, 105, 107, 109, 111 and 115 and background area 113 is needed. Step 311 determines the spatial positioning of the dynamic toolbar 101 on multimedia page 100. Dependant upon the spatial positioning of the dynamic toolbar 101 on multimedia page 100 various other options are available. Step 315 determines the position of dynamic toolbar 101 relative to each content area 103, 105, 107, 109, 111 and 115 and the background area 113. Step 321 configures the dynamic toolbar 101 by changing the pulldown menu 123 options available to the dynamic toolbar 101, dependant upon if the dynamic toolbar 101 is positioned over each content area 103, 105, 107, 109, 111 and 115 or background area 113. Additionally, the information window 121 of dynamic toolbar 101 will be updated to reflect the current positioning of the dynamic toolbar 101. The index button 125 displays the number of mouse clicks available to the user in order to change the background color options, text color options, font options and other menu options as discussed in FIGS. 5A-D. Step 331 detects the number of mouse clicks performed upon the index button 125. Dependant upon the number of mouse clicks input by the user, the multimedia options available to the user change. Afterwards, the process or method proceeds to FIG. 4.

FIG. 4 illustrates an exemplary flow chart useful for explaining the operation of an embodiment of the dynamic toolbar. Generally, the number of mouse clicks input by the user (determined by step 331) determine what options are available to the user from the lookup tables in FIGS. 5A-D. However, the type of page the user is navigating (determined from step 301) and the spatial positioning of the dynamic toolbar 101 (determined from steps 305, 311 and 315) also determine what options are available to the user from the lookup tables in FIGS. 5A-D.

The method continues from step 331 of FIG. 3, and then proceeds to step 401. Step 401 illustrates the index button options available to the user by clicking the index button 125 via the mouse once. In this embodiment, when the user clicks index button 125 one time, the background color options panel is accessible for eligible areas. The eligible areas are determined from the table in FIG. 5A.

FIG. 5A is divided by the multimedia page type: main page, media page and question/answer page. Within each of the lower columns are small boxes corresponding to a type of content area or background area that are eligible for the background color options panel. For example, FIG. 5A illustrates that the background color options panel is available if the dynamic toolbar 101 is positioned over either the text area 505, main page area 507 or screen area 509 of the main page. Therefore, when the user is on the main page and the dynamic toolbar is located over either the text area 505, main page area 507 or screen area 509, and the user clicks the index button 125 one time, then the background color options panel will be available for use.

For example, FIG. 5A illustrates that the background color options panel is available if the dynamic toolbar 101 is positioned over either the text area 511 or screen area 513 of the media page. Therefore, when the user is on the media page and the dynamic toolbar is located over either the text area 511 or screen area 513, and the user clicks the index button 125 one time, then the background color options panel will be available for use.

For example, FIG. 5A illustrates that the background color options panel is available if the dynamic toolbar 101 is positioned over either the text area 515, screen area 517 or question/answer area 519 of the Q/A page. Therefore, when the user is on the Q/A page and the dynamic toolbar is located over either the text area 515, screen area 517 or question/answer area 519, and the user clicks the index button 125 one time, then the background color options panel will be available for use.

Step 421 illustrates the index button options available to the user by clicking the index button 125 via the mouse twice. In this embodiment, when the user clicks index button 125 two times, the text color options panel is accessible for eligible areas. The eligible areas are determined from the table in FIG. 5B.

FIG. 5B is divided by the multimedia page type: main page, media page and question/answer page. Within each of the lower columns are small boxes corresponding to a type of content area or background area that are eligible for the text color options panel. For example, FIG. 5B illustrates that the text color options panel is available if the dynamic toolbar 101 is positioned over either the text area 523 or the main page area 525 of the main page. Therefore, when the user is on the main page and the dynamic toolbar is located over either the text area 523 or main page area 525, and the user clicks the index button 125 two times, then the text color options panel will be available for use.

For example, FIG. 5B illustrates that the text color options panel is available if the dynamic toolbar 101 is positioned over the text area 527 of the media page. Therefore, when the user is on the media page and the dynamic toolbar is located over the text area 527, and the user clicks the index button 125 two times, then the text color options panel will be available for use.

For example, FIG. 5B illustrates that the text color options panel is available if the dynamic toolbar 101 is positioned over either the text area 529 or the question/answer area 531 of the Q/A page. Therefore, when the user is on the Q/A page and the dynamic toolbar is located over either the text area 529 or the question/answer area 531, and the user clicks the index button 125 two times, then the text color options panel will be available for use.

Step 441 illustrates the index button options available to the user by clicking the index button 125 via the mouse three times. In this embodiment, when the user clicks index button 125 three times, the font options panel is accessible for eligible areas. The eligible areas are determined from the table in FIG. 5C.

FIG. 5C is divided by the multimedia page type: main page, media page and question/answer page. Within each of the lower columns are small boxes corresponding to a type of content area or background area that are eligible for the font options panel. For example, FIG. 5C illustrates that the font options panel is available if the dynamic toolbar 101 is positioned over either the text area 543 or the main page area 545 of the main page. Therefore, when the user is on the main page and the dynamic toolbar is located over either the text area 543 or main page area 545, and the user clicks the index button 125 three times, then the font options panel will be available for use.

For example, FIG. 5C illustrates that the font options panel is available if the dynamic toolbar 101 is positioned over the text area 547 of the media page. Therefore, when the user is on the media page and the dynamic toolbar is located over the text area 547, and the user clicks the index button 125 three times, then the font options panel will be available for use.

For example, FIG. 5C illustrates that the font options panel is available if the dynamic toolbar 101 is positioned over either the text area 549 or the question/answer area 551 of the Q/A page. Therefore, when the user is on the Q/A page and the dynamic toolbar is located over either the text area 549 or the question/answer area 551, and the user clicks the index button 125 three times, then the font options panel will be available for use.

Step 461 illustrates the index options available to the user by clicking the index button 125 via the mouse four times. In this embodiment, when the user clicks index button 125 four times, the menu options panel is accessible for eligible areas. The eligible areas are determined from the table in FIG. 5D.

FIG. 5D is divided by the multimedia page type: main page, media page and question/answer page. Within each of the lower columns are small boxes corresponding to a type of content area or background area that are eligible for the menu options panel. For example, FIG. 5D illustrates that the menu options panel is available if the dynamic toolbar 101 is positioned over either the text area 563, main page area 565, image areas 567 or screen area 569 of the main page. Therefore, when the user is on the main page and the dynamic toolbar is located over either the text area 563, main page area 565, image areas 567 or screen area 569, and the user clicks the index button 125 four times, then the menu options panel will be available for use. In this embodiment, the menu options may allow the user to insert a jpeg background into the text area, add new text to the text area, change the number of characters per page on the main page, add a picture inside of text within the main page or text area, narration of page. However, it is understood, that this is one embodiment of the invention, and that other embodiments exist.

For example, FIG. 5D illustrates that the menu options panel is available if the dynamic toolbar 101 is positioned over either the text area 571, image area 573, screen area 575 or video area 577 of the media page. Therefore, when the user is on the media page and the dynamic toolbar is located over either the text area 571, image area 573, screen area 575 or video area 577, and the user clicks the index button 125 four times, then the menu options panel will be available for use.

For example, FIG. 5D illustrates that the menu options panel is available if the dynamic toolbar 101 is positioned over either the text area 579, image areas 581 or screen area 583 of the Q/A page. Therefore, when the user is on the Q/A page and the dynamic toolbar is located over either the text area 579, image areas 581 or screen area 583, and the user clicks the index button 125 four times, then the menu options panel will be available for use.

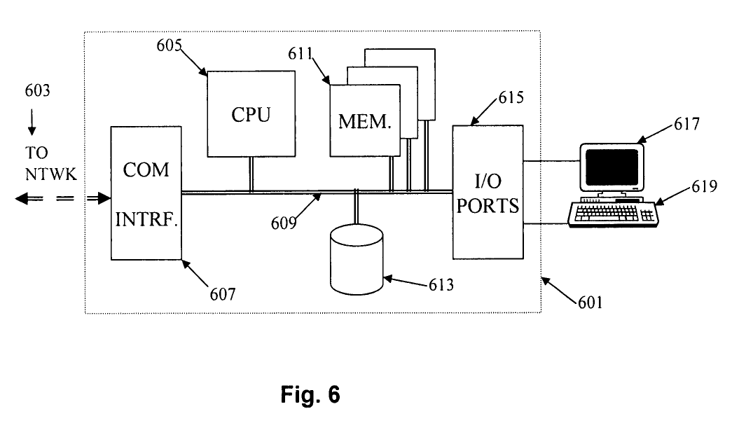

FIG. 6 is a functional block diagram of a PC based implementation of a computer or computer system 601, which may serve as the user terminal. The exemplary system 601 contains a central processing unit (CPU) 605, memories 611 and an interconnect bus 609. The CPU 605 may contain a single microprocessor (e.g. an x86 microprocessor), or it may contain a plurality of microprocessors for configuring the computer system 605 as a multi-processor system. The memories 611 include a main memory, such as a dynamic random access memory (DRAM), as well as a read only memory, such as a PROM, an EPROM, a FLASH-EPROM, or the like. The system 601 also includes mass storage devices such as various disk drives, tape drives, etc. The main memory typically includes dynamic random access memory (DRAM) and high-speed cache memory. In operation, the main memory stores at least portions of instructions and data for execution by the CPU 605.

The mass storage may include one or more magnetic disk or tape drives or optical disk drives, for storing data and instructions for use by CPU 605. For a home PC, for example, at least one mass storage system 613 in the form of a disk drive or tape drive, stores the operating system and application software as well as data, such as received messages and documents. The mass storage 613 within the computer system 601 may also include one or more drives for various portable media, such as a floppy disk, a compact disc read only memory (CD-ROM), or an integrated circuit non-volatile memory adapter (i.e. PC-MCIA adapter) to input and output data and code to and from the computer system 601.

The system 601 also includes one or more input/output interfaces for communications, shown by way of example as an interface 607 for data communications via the network 603. The interface 607 may be a modem, an Ethernet card or any other appropriate data communications device, for digital communications of various types via the network 603. The physical communication links may be optical, wired, or wireless (e.g., via satellite or cellular network).

The computer system 601 may further include appropriate input/output ports 615 for interconnection with a display 617 and a keyboard 619 serving as the respective user interface. For example, the computer may include a graphics subsystem to drive the output display 617. The output display 617 may include a cathode ray tube (CRT) display or liquid crystal display (LCD). Although not shown, the PC type system typically would include a port for connection to a printer. The input control devices for such an implementation of the system 601 would include the keyboard 619 for inputting alphanumeric and other key information. The input control devices for the system may further include a cursor control device (not shown), such as a mouse, a trackball, stylus, or cursor direction keys. The links of the peripherals 617, 619 to the system 601 may be wired connections or use wireless communications.

Each computer system 601 runs a variety of applications programs and stores data, enabling one or more interactions via the user interface, provided through elements such as 617 and 619, and/or over the network 603 to implement the desired processing for the dynamic toolbar service or the processing of requests for dynamic toolbar services.

At different times all or portions of the executable code or database for any or all of these software elements may reside in physical media or be carried by electromagnetic media. Physical media include the memory of the computer processing systems 601, such as various semiconductor memories, tape drives, disc drives and the like of general-purpose computer systems. Thus, another type of media that may bear the software elements includes optical, electrical and electromagnetic waves, such as used across physical interfaces between local devices, through wired and optical landline networks and over various air-links.

Hence, operations described above may be carried out by execution of software, firmware, or microcode operating on a router or computer of any type. Additionally, code for implementing such operations may be in the form of computer instruction in any form (e.g., source code, object code, interpreted code, etc.) stored in or carried by any computer or machine readable medium.

The term “computer-readable medium” as used herein refers to any medium that participates in providing instructions to a processor for execution. Such a medium may take many forms, including but not limited to, non-volatile media, volatile media, and transmission media. Non-volatile media include, for example, optical or magnetic disks, such as any of the storage devices in the systems of FIG. 6. Volatile media include dynamic memory, such as main memory. Transmission media include coaxial cables; copper wire and fiber optics, including the wires that comprise a bus within a computer system. Transmission media can also take the form of electric or electromagnetic signals, or acoustic or light waves such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave transporting data or instructions, or any other medium from which a computer can read. Various forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method, for providing a toolbar to navigate multimedia pages, the method comprising:
determining a type of said multimedia page being navigated;
determining a position of said toolbar and a relative position of contents of said page;
determining options available to said toolbar;
changing a status window on said toolbar reflecting said relative position of said toolbar and said contents of said page;
changing said status window on said toolbar reflecting options available to said toolbar;
providing the customization of said options of said toolbar;
determining the options available to said toolbar from said position of said toolbar, said relative position of said contents of said page, said type of said page being navigated and the number of clicks input by the user.
